(19) United States
(12) Patent Application Publication
(10) Pub. No.: US 2016/0019243 A1
(43) Pub. Date: Jan. 21, 2016

(54) TEMPLATE METADATA

(71) Applicant: Elateral, Inc., Westchester, IL (US)

(72) Inventors: Alexandre Perry Kamel, Castle Pines, CO (US); Peter Blackburn, Farnham (GB); Paul Goater, Farnham (GB)

(21) Appl. No.: 14/771,712

(22) PCT Filed: Mar. 5, 2014
(86) PCT No.: PCT/US2014/020694

§ 371 Date: Aug. 31, 2015

Related U.S. Application Data
(60) Provisional application No. 61/851,337, filed on Mar. 7, 2013.

(51) Int. Cl. G06F 17/30

(52) U.S. Cl. CPC G06F 17/30292; G06F 17/30598

(57) ABSTRACT

A template metadata system and a process for attaching descriptive information to metadata of a template are described. The template metadata process can include, but is not limited to, characterizing template properties for purposes of finding, filtering, organizing, and processing a database of templates. The template metadata system includes a server, a template database, a network, and an end user device. In one embodiment, the template metadata system can generate input parameters for discovering a pre-existing template from among a collection of templates stored in a template database.

### CROSS-REFERENCE TO RELATED APPLICATION

This application claims the benefit of U.S. Provisional Application No. 61/851,337, filed Mar. 7, 2013.

### BACKGROUND

Templates are used for a variety of communication materials. Templates enable communication materials to be created and/or assembled based on pre-defined patterns or layouts. As such, templates are useful for enhancing consistency, control, speed, and efficiency in the production of related content and communications materials. There are many examples of templates used for designing, constructing, assembling, and/or producing content for a wide variety of applications. These can range from internal to external communications in a variety of media types.

Templates are frequently developed based on a creative design schema. Typically, when a graphic designer creates a design for a particular communication, if the document is intended to be reused a template is developed. The template can include rules that specify various components included in the template layout. Components can include content areas and content objects. Generally, some components are fixed components while others are variable components.

As such, template-based documents enable fast and flexible creation of new document versions by simply adjusting components included in the template. The template therefore maintains consistency in look, feel, and layout of the document versions, while still allowing for rules to be established governing types of images, copy, and/or text options available for use in various document versions.

In a typical situation, a graphic designer specifies a layout for which a template is desired. Templates are meant to be reused in order to create various document versions having the same feel. Once an initial document, corresponding layout, and initial content objects are completed, a template is then created in an appropriate media. Generally, templates are created in certain media types based on an intended use of the template-based document versions. Creating templates varies depending on intended media and can include developing software programming or scripting for each template. Designing and developing a template based on an initial master document design can cost a significant amount depending on the complexity of the template and related design. The time required to design and develop such a template can also be considerable.

An effective use of templates is impaired by missing and/or inadequate methods to characterize properties of templates for purposes of searching, finding, filtering, and otherwise processing templates.

Considerable time and expense could be saved if, rather than creating a new template in order to accommodate a document design, a pre-existing template that reasonably meets the needs of the document design could be found, retrieved, and reutilized.

### BRIEF DESCRIPTION OF THE DRAWINGS

FIG. 1 is a flow chart of a template metadata process according to one embodiment of the present invention.

FIG. 2 is a flow chart of a template metadata process according to one embodiment of the present invention.

FIG. 3A is a block diagram of a first example template according to one embodiment of the present invention.

FIG. 3B is a first example of a template metadata table according to one embodiment of the present invention.

FIG. 3C is an example of an XML table according to one embodiment of the present invention.

FIG. 3D is a block diagram of a second example template according to one embodiment of the present invention.

FIG. 3E is a second example of a template metadata table according to one embodiment of the present invention.

FIG. 4 is a block diagram of a template metadata system according to one embodiment of the present invention.

FIG. 5 is a flow chart of a template database query process according to one embodiment of the present invention.

FIG. 6 is a block diagram of a template metadata system according to one embodiment of the present invention.

### DETAILED DESCRIPTION

Embodiments of the present invention include a template metadata system and a process for attaching descriptive information to metadata of a template. In one embodiment, the template metadata system can include a server, a template database, a network, and an end user device. The template metadata process can include, but is not limited to, characterizing template properties for purposes of finding, filtering, organizing, and processing a database of templates. It is to be appreciated that templates can include, but are not limited to, media templates, print templates, paper templates, patterns, stencils, pre-developed layouts, form letters, pre-formatted documents, structured frameworks and/or structured layouts.

The template metadata system can generally include storing template metadata on a server. Generally, the server can include a database to store the templates and the database can be accessible to one or more end users.

In one embodiment, the process can be implemented to attach structured information describing a template to metadata of a template. Generally, metadata can be implemented to describe a template and serve to facilitate characterization of properties of the template. Metadata can be useful in cataloging or organizing templates in libraries, repositories, or template management systems. For instance, metadata can be implemented to identify a template as having an image, the image having a media format and file density. In some embodiments, metadata can further characterize what the image is of. For example, the metadata can include information indicating that the image is of a person, whether the person is male or female, and what ethnicity the person in the image is. Descriptive information associated with template metadata can be useful for purposes of searching, filtering, categorizing, organizing, finding, and retrieving templates which may be suitable for particular communications initiatives.

Generally, the process for creating template metadata can include defining content objects of a template and attaching information related to the content objects to metadata of the template. Content objects may include, but are not limited to, images, plain text, WYSIWYG text, and backgrounds. To create different versions of a particular document, content objects can be altered or changed in the template. For instance, an image content object can be changed from one image to another image. As an example, a picture of a dog can be changed to a picture of a cat for a pet food communications campaign. Content objects can be changed in a template to create new communications materials or documents which utilize a similar layout of the previously defined template.

Characteristics including, but not limited to, shape, size, graphic resolution, font type, etcetera can be defined for each content object and attached to metadata of a template. For instance, a location of each content object in the template can be defined and attached to the metadata. In some embodiments, a relationship between content objects including, but not limited to, relative orientation, alignment, and logical interdependencies can be defined and included in the template metadata. Generally, characteristics related to content objects can include, but are not limited to, individual attributes, collective attributes, relationships, sizes, shapes, positions, orientations, relative positions, relative orientations, relative sizes, and other descriptive attributes of the content objects. Characteristics can further include relationships and interdependencies between and among content objects.

In some embodiments, template metadata can include performance characteristics related to a template, a type or category of the template, and a design of the template. For instance, performance characteristics associated with a template based on prior use can be included in the template metadata. It is to be appreciated that a variety of information related to descriptive information deemed useful in specifying design requirements of a template can be included. Generally, characteristics or design parameters of a template can be attached to metadata of the template to facilitate searching, pattern recognition, pattern matching, sorting, filtering, prioritizing, organizing, and/or managing templates for a variety of media and communications types.

In some embodiments, Cartesian coordinates can be implemented to describe a location of content objects in two-dimensional templates. Cartesian coordinates can be implemented in print or electronic media. In one embodiment, Cartesian coordinates can be implemented to describe a location of various content and/or physical objects in three-dimensional display units or kiosks. It is to be appreciated that other coordinate systems can be implemented including, but not limited to, vector-based coordinates and radial mapping coordinates. Similar to implementing Cartesian coordinates, other coordinate systems can be implemented to describe locations of and/or spatial relationships between content objects in a template. In one embodiment, vector-based or radial mapping coordinates can be implemented to describe a location of and/or spatial relationships between content and/or physical objects in three-dimensional display units or kiosks.

Typically, template metadata can be implemented in multi-channel marketing communications and advertisements, interactive digital marketing communications, and related content and document management areas. Generally, template metadata can be implemented with printed and electronic documents, in two dimensions or three dimensions, which are constructed using templates, patterns, structured frameworks, and/or structured layouts. For instance, template metadata can be implemented with documents including, but not limited to, web pages, email communications, print advertising, point-of-sale marketing materials, social marketing pages, billboard, posters, mobile web pages, mobile application screens, and other documents that make use of structured formatting.

Generally, data attached to template metadata can include, but is not limited to, data characterizing general properties of a template, data characterizing properties of content objects included in the template, data characterizing relationships between documents and templates, and data characterizing relationships between content objects in the template. The data attached to template metadata can facilitate coarse and/or refined levels of template pattern recognition and pattern matching when searching, filtering, and comparing a collection of templates.

Embodiments of the present invention can include a system and a process for querying a template database based on a draft template analyzed by recognition software. In one embodiment, the process can be implemented to simplify, expedite, and improve specification of template metadata parameters. In another embodiment, the process can be implemented to define attributes of a template, including two and three-dimensional templates, in a variety of mediums and formats. Generally, the system can include an application having recognition software. In one embodiment, the system and the process can implement photo recognition technology with a draft template in order to specify properties and/or attributes of the draft template. The process can then generate an output adapted for searching a template database. The system and the process can allow for fast, efficient, effective, and accurate specification of template attributes with little or no knowledge of underlying template metadata attributes or related algorithms.

In one embodiment, an application can be adapted to identify templates that have similar characteristics to a reference template based on a comparison of descriptive template metadata that characterizes attributes of a template. In one embodiment, the application can be adapted to allow a user to specify attributes of one template to query a template database and generate a list of other templates having similar attributes. In one example, the templates can be sorted by degree of consistency with the attributes of the reference template. In one embodiment, the application can be adapted to sort the list of templates by additional attributes including, but not limited to, historical performance characteristics of the templates.

Embodiments of the present invention include one or more means of specifying metadata to characterize properties of two-dimensional templates and three-dimensional display templates. Generally, the means can include characteristics, properties, or parameters of a template that may be deemed useful in identifying and/or characterizing similarities and/or differences between various templates and a collection of templates. In an embodiment, the means can include specification of content object types in the template. In an embodiment, the means can include specification of characteristics of each content object including, but not limited to, shape, size, and other attributes. In an embodiment, the means can include an absolute and a relative location of such content object in the template. In an embodiment, the means can include specification of relationships between and among content objects including, but not limited to, relative orientation, alignment, and interdependencies that may exist between content objects in a template.

In one embodiment, content objects of a template can be analyzed to generate data to include in the template metadata. For instance, for text objects in a template, text attributes can be analyzed including, but not limited to, permitted and non-permitted languages, permitted and non-permitted font type(s), permitted and non-permitted font sizes, and permitted and non-permitted ranges of font sizes. In one embodiment, a purpose of a text content object can be analyzed including, but not limited to, headline, sub-headline, body copy, call to action, legal disclaimer, required legal information, offering, pricing, and other purposes.

In one embodiment, an application can be implemented to search, review, evaluate, analyze, filter, compare, arrange, and process templates. In some embodiments, the same application can be adapted to analyze characteristics of templates and characteristics of content objects. For instance, the application can include an interactive user interface, a decision support system, and/or an expert system designed to facilitate such processing.

Embodiments of the present invention can include a process implementing photo recognition to capture and specify properties, characteristics, attributes, and template metadata of a desired template. The process can be implemented to find templates from a collection of templates that match a desired template. The process can filter, compare, analyze, and process the collection of templates based on a degree to which characteristics, attributes, properties and/or template metadata match with the desired template.

In one embodiment, pattern recognition algorithms can be implemented to search, filter, compare, analyze, and process properties, characteristics, attributes, and template metadata of a collection of templates to one or more desired templates.

Embodiments of the present invention can improve an overall effectiveness in designing communications materials and other documents. Instead of beginning with a design and then building a corresponding template from the design, a campaign designer can first find, filter, review, and/or evaluate pre-existing templates that meet general design needs. From the pre-existing templates, the campaign designer can select pre-existing templates that have proven to be successful in similar communications. The campaign designer of a document can choose to adapt the design in order to work effectively with selected pre-existing templates.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), an erasable programmable read-only memory (EPROM or Flash memory), an optical fiber, a portable compact disc read only memory (CD-ROM), and a digital video disk read only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, of otherwise professed in a suitable manner, if necessary, and then stored in a computer memory.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The terms “content analytics” or “asset analytics,” as used in this specification and the appended claims, refer to an assessment and characterization of an asset's demonstrated capacity to contribute to an effectiveness of a communications initiative under a variety of communications contexts with regard to an achievement of a variety of desired outcomes, whether for discrete initiatives, types of initiatives, or cumulative impact across all initiatives where the asset has participated over a span of time.

The term “recognition software,” as used in this specification and the appended claims, refers to any software adapted to recognize one or more characteristics of a document. Recognition software can include, but is not limited to, facial recognition software, optical character recognition software, and image recognition software.

### An Embodiment of a Template Metadata Process

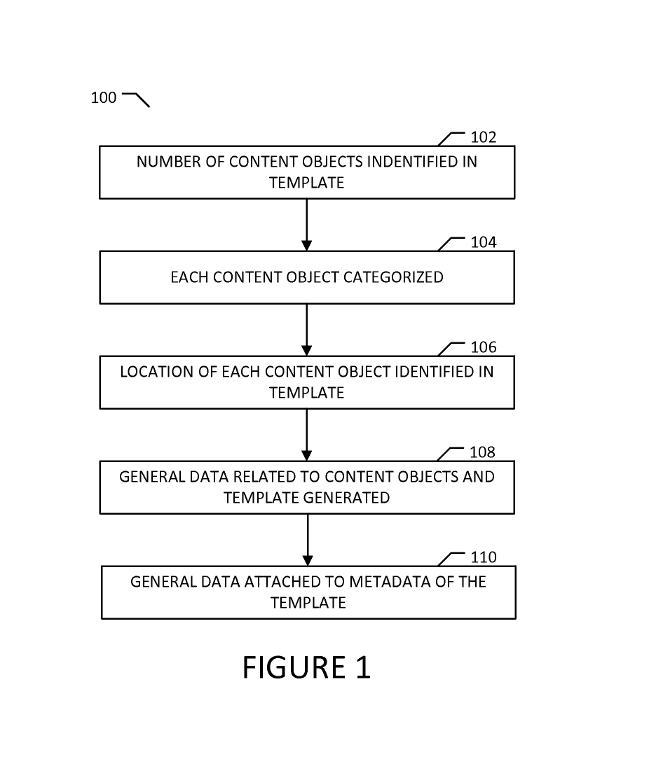

Referring to FIG. 1, a flow chart of a method or process 100 is illustrated. The template process 100 can be implemented to attach general template data to metadata of a template.

In block 102, a number of content objects in a template can be identified. Typically, a template can have one or more content objects. Content objects can include, but are not limited to, backgrounds, images, text, video, audio, and combinations thereof. In one embodiment, a computer program can be implemented to determine the number of content objects in a template. For instance, the computer program can identify various content objects based on photo recognition. In another instance, the computer program can be adapted to identify content objects based on text recognition. In some embodiments, a user can determine the number of content objects in a template. For instance, a designer creating a template can input the number of content objects included in the template.

After the number of content objects is determined, each of the content objects can be categorized in block 104. Categories of content objects can include, but are not limited to, images, plain text boxes, free text boxes, WYSIWYG text boxes, and backgrounds. It is to be appreciated that a template can have a variety of types of content objects. Typically, each content object can be categorized into one of a plurality of categories. For instance, an image of a dog and an image of a hotel can be generally categorized as images.

In block 106, a location of each content object can be identified in the template. For example, in a template having a first image field, a text box, and a second image field, a location of each of the content objects can be identified. For instance, the first image field may be located on a left hand side of the template, the text box may be located on a bottom third of the template, and the second image field may be on the right hand side of the template. Generally, a predetermined location system can be implemented for each template. For instance, a template can include a Cartesian coordinate system as the location system for determining positions of content objects in the template. It is to be appreciated that other types of location systems can be implemented without exceeding a scope of the present invention.

After the content objects have been identified and located, general data can be generated relating to the content objects in block 108. General data including, but not limited to, number of content objects, shapes of content objects, location of content objects, and category of each content object can be generated. In one embodiment, general data about the template can be generated in block 108. For instance, template data can include, but is not limited to, media type, template shape, dimension units, size, location system, and other relevant information.

In block 110, general data related to the content objects and the template can be attached to metadata of the template. It is to be appreciated that any means for attaching data to metadata can be implemented without exceeding a scope of the present invention.

Referring to Table 1, one example of a plurality of data fields indicating general attributes or information about a template that can be included in template metadata is shown. Table 1 further indicates what type of input can be allowed for each attribute. It is to be appreciated that more or less data fields can be implemented without exceeding a scope of the present invention.

TABLE 1
General Template Characteristics

| ATTRIBUTE | INPUT TYPE |
|---|---|
| Media Type | Free Text |
| Template Shape | Free Text |
| Dimension Units | Free Text |
| Dimensions: Height | Numeric |
| Dimensions: Width | Numeric |
| Cartesian Origin | Free Text |
| Number of Objects | Integer Value |
| Sequence of Objects | Alphanumeric |
| Object Types | Free Text |
| Object Shapes | Free Text |

As shown in Table 1, attributes describing the template in general can include, but are not limited to, media type, template shape, dimension units, height, width, Cartesian origin, number of objects, sequence of objects, object types, and object shapes. The “Media Type” field can be implemented to describe the type of media the template is intended to be used with. For instance, the media type can include, but is not limited to, web pages, email communications, print advertising, point of sale marketing materials, social marketing pages, billboards, posters, mobile web pages, mobile application screens, and similar documents and digital media that make use of templates. The “Template Shape” field can be implemented to give a general description of the shape of the template. The “Dimensions Unit” field can be implemented to indicate whether the Metric system or English system is used for defining dimensions. The “Height” and “Width” fields can be used to give measurements for a height and a width of the template. The “Cartesian Origin” field can be implemented to indicate an origin (0,0) for plotting content objects in the template. The “Number of Objects” field can be implemented to indicate the number of content objects in the template. The “Sequence of Objects” field can be implemented to describe a sequencing of content objects to be specified in the metadata. The “Object Types” field can be implemented to list each type or category of content object in the template. The “Object Shapes” field can be implemented to list each shape of the content objects that are in the template.

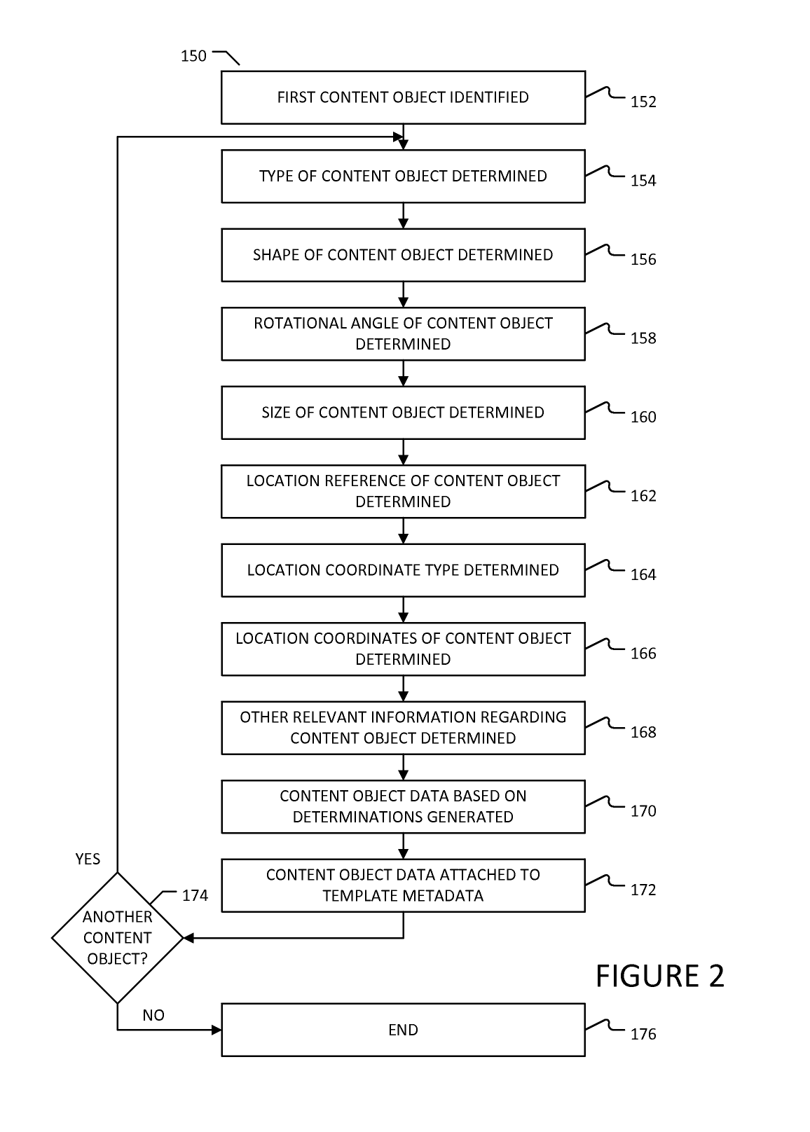

Referring to FIG. 2, a flow chart of a method or process 150 is illustrated. The content object process 150 can be implemented to attach content object data to metadata of a template. Generally, characteristics including, but not limited to, shape, size, graphic resolution, font type, etcetera can be defined for each content object. For instance, data to be included in the template metadata for an image can include maximum image resolution, minimum image resolution, size, type of image allowed, and orientation. After data has been attached to the template metadata, the template can be searched based on general information about the template along with information related to each content object in the template.

In block 152, a first content object can be identified in a template. Generally, the total number of content objects can be identified in the template process 100. The content object process 150 can be adapted to identify a first content object to generate and attach data to metadata of the template in block 152.

After the first content object is identified in block 152, a type or category of the content objet can be determined in block 154. Generally, a detailed determination of the type of content object can occur in block 154. For instance, if the first content object is an image, the content object process 150 can be implemented to determine what file format the first content object is. For instance, the image could be a jpeg file format, a bitmap file format, or a tiff file format.

In block 156, the shape of the first content object can be determined. General shape types can be implemented to describe a shape of the first content object. For instance, the shape can include, but is not limited to, a circle, a rectangle, a square, a triangle, etc. It is to be appreciated that the content object may not have a specific shape. In such an instance, a shape closest to the shape of the content object can be utilized.

A rotational angle of the first content object can be determined in block 158. Generally, a degree of rotation can be determined. For instance, the first content object can be rotated from 0 to 360 degrees.

In block 160, a size of the first content object can be determined. Generally, the size of the content object will be measured based on what shape the content object is. For instance, if the content object is a square or a rectangle, a height and width can be implemented to determine a size of the content object. If the content object is a circle, a diameter or radius measurement can be implemented to determine a size of the content object.

In block 162, a location reference can be determined. Typically, the template will have a predefined location reference which can be implemented for each content object. For instance, a lower left corner can be one example of a location reference. As such, each location coordinate will reference the lower left corner of each content object.

After the location reference is determined, the location coordinate type can be determined in block 164. Generally, the location coordinate type will be universal for each content object. For instance, Cartesian coordinates can be implemented as a location coordinate type. It is to be appreciated that a variety of location coordinate types can be implemented in the present invention including, but not limited to, a polar coordinate system and a spherical coordinate system.

Once the location coordinate type and location reference are determined, a location coordinate of the first content object can be determined in block 166. Following the above example, if the lower left corner and Cartesian coordinates are implemented, an image in the upper half of a template can have Cartesian coordinates given in (X,Y) format.

In block 168, other relevant information regarding the content object can be determined. For instance, in some embodiments a maximum resolution for images may be deemed relevant. In another instance, font type and/or font size may be deemed relevant and can be determined.

In block 170, data can be generated based on the previous determinations in blocks 154-168. Once the data is generated, the data can be attached to the template metadata in block 172.

After the data has been attached to the metadata, the process 150 can move to decision block 174. In decision block 174, whether there is another content object can be determined. If there is another content object, the process 150 can return to block 154. The process 150 can repeat for each content object in the template. If there are no more content objects, the process 150 can end in block 176.

Referring to Table 2, one example of a plurality of data fields related to content objects that can be included in the template metadata is shown. Table 2 further shows what type of input can be allowed for each attribute.

TABLE 2
Content Object Characteristics

| ATTRIBUTE | INPUT TYPE |
|---|---|
| Type | Free Text |
| Shape | Free Text |
| Rotational Angle | Numeric |
| Size | Numeric |
| Location Reference | Free Text |
| Location Coordinate Type | Free Text |
| Location Coordinates | Numeric |
| Other | Free Text |

As shown in Table 2, attributes describing the content objects can include, but are not limited to, type, shape, rotational angle, size, location reference, location coordinate type, location coordinates, and other. The “Type” field can be implemented to indicate what the content object is. For instance, the content object can be an image, a plain text box, a WYSIWYG text box, etc. The “Shape” field can be implemented to indicate a general shape of the content object. The “Rotational Angle” field can be implemented to indicate if the content object has been rotated. For instance the rotational angle can indicate if the content object has been rotated from 0 to 360 degrees. The “Size” field can be implemented to indicate a size of the content object. For instance, the size can be indicated by length and width, radius, length, width, height, etc. The “Location Reference” field can be implemented to indicate where the location coordinates reference the content object. For instance, the location coordinates can reference an upper-left edge or a center of the content object. The “Location Coordinates” field can be implemented to indicate coordinate values. For instance, if Cartesian coordinates are used, (X,Y) coordinates can be included. The “Other” field can be implemented to include any information found pertinent to a particular template.

Generally, characteristics including, but not limited to, shape, size, graphic resolution, font type, etcetera for each content object can be defined and attached to the template metadata. In one embodiment, a location of each content object in the template can be defined and attached to the metadata. In some embodiments, a relationship between content objects including, but not limited to, relative orientation, alignment, and logical interdependencies can be defined and included in the template metadata. In one embodiment, performance characteristics associated with a template based on prior use can be included in the template metadata. It is to be appreciated that a variety of information related to descriptive information deemed useful in specifying design requirements of a template can be included.

### Example Templates and Metadata Related to the Example Templates

Generally, the template process 100 and the content object process 150 for creating template metadata can include defining a template, defining content objects of the template, and attaching data related to the template and the content objects to metadata of the template. Examples of two templates and data related to the example templates are provided hereinafter.

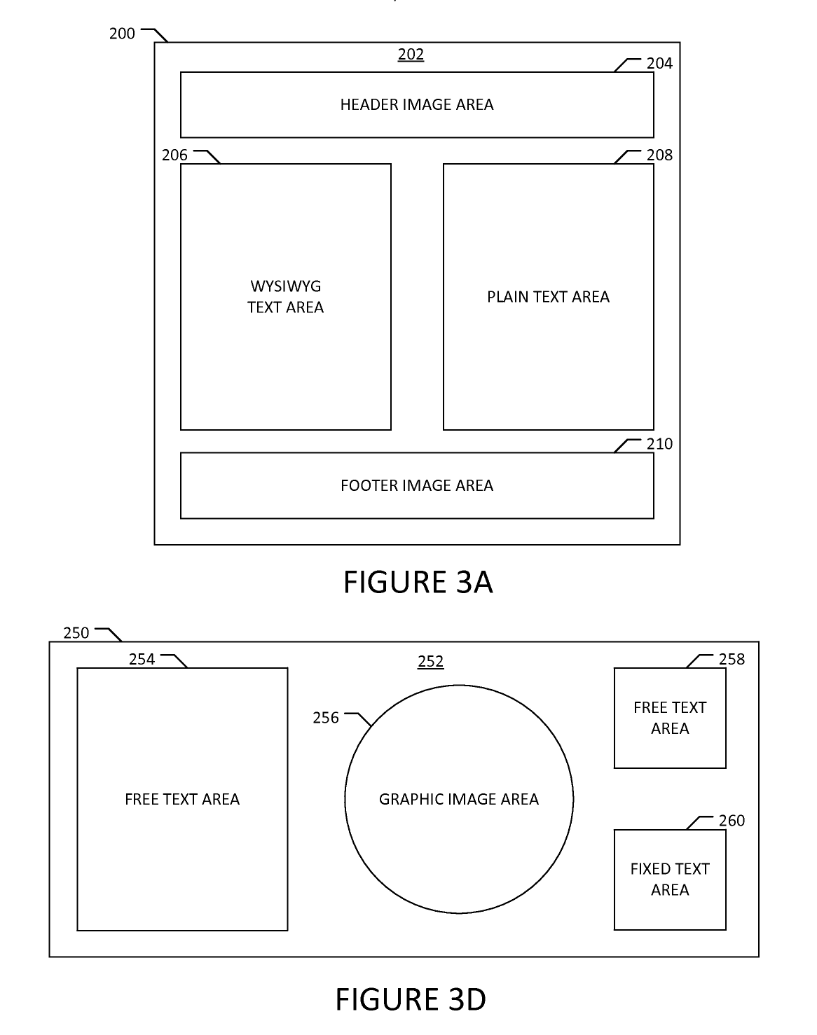

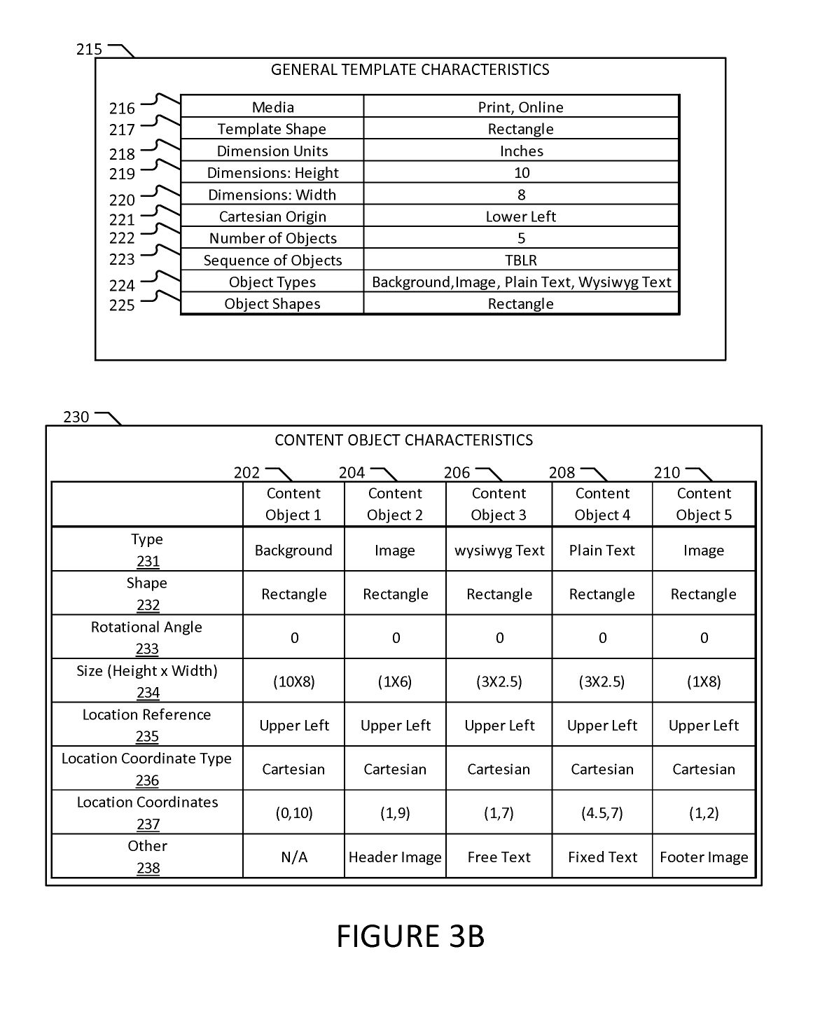

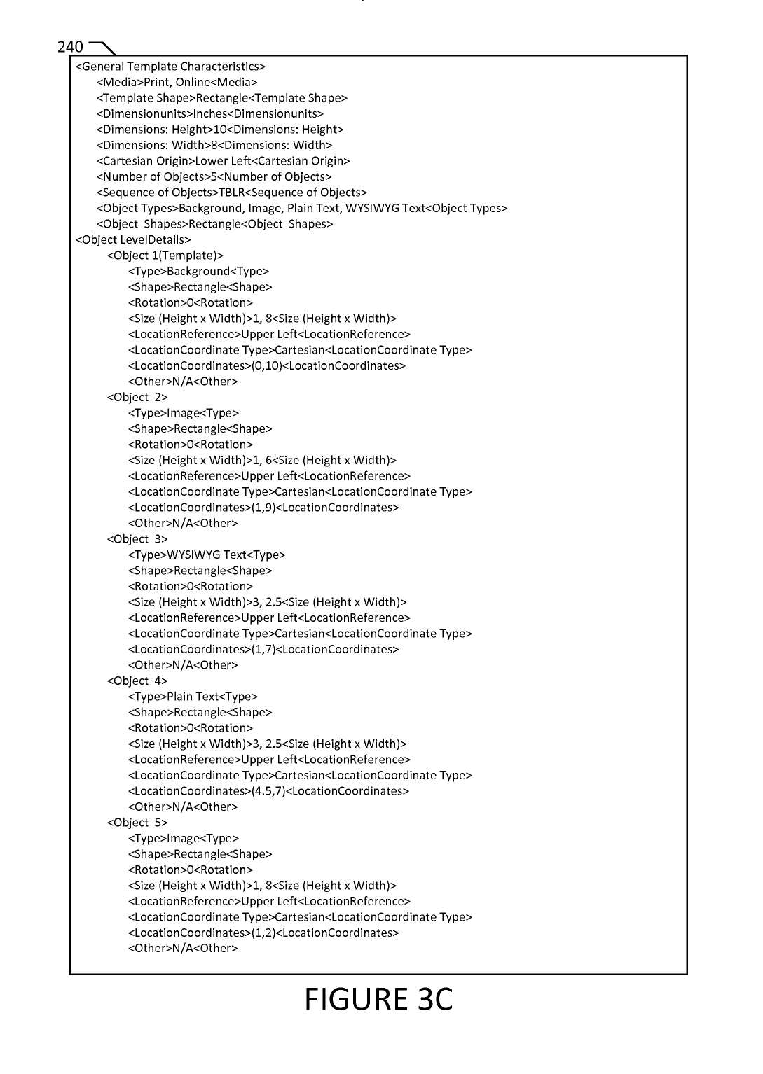

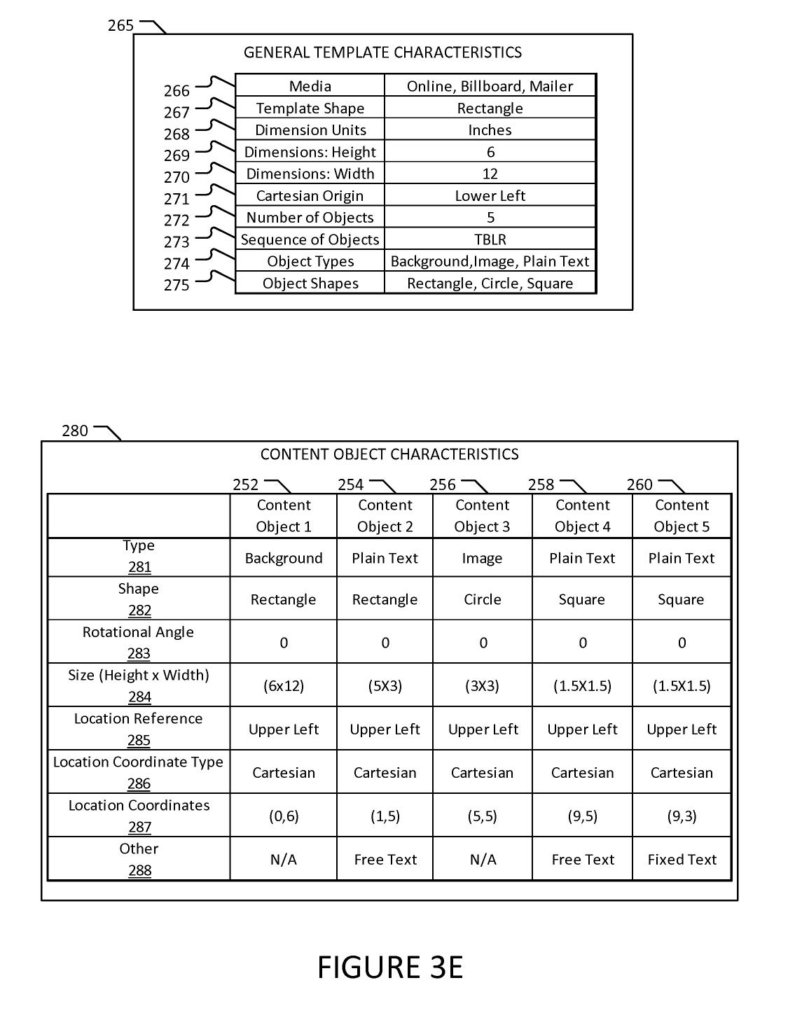

Referring to FIGS. 3A-3C, a first template 200, a general metadata table 215, a content object metadata table 230, and an XML metadata table 240 are illustrated. Referring to FIGS. 3D-3E, a second template 250, a general metadata table 265, and a content object metadata table 280 are illustrated.

The first template 200 and the second template 250 are provided for illustrative purposes only and are not meant to be limiting. Templates typically specify a format or layout for a particular document type. The format can establish certain areas on a document where content objects are to be positioned. Templates can include other characteristics and/or constraints associated with each of the content objects. The example metadata tables include characteristics that can be implemented to describe a template. It is to be appreciated that other characteristics can be implemented without exceeding a scope of the present invention.

Referring to FIG. 3A, the first template 200 can include a plurality of content objects. As shown, a first content object 202 can be a background, a second content object 204 can be an image, a third content object 206 can be a text box, a fourth content object 208 can be a text box, and a fifth content object 210 can be an image.

In one example, the first template 200 can be a document intended for print or online media. The second content object 204 can be a header graphic image, the third content object 206 can be a WYSIWYG text box, the fourth content object 208 can be a plain text box, and the fifth content object 210 can be a footer graphic image. The header graphic image 204 can be positioned along an upper border of the first template 200. The rectangular WYSIWYG text box 206 can be located in a left middle half of the first template 200 beneath the header graphic image 204. The plain text box 208 can be adjacent to the WYSIWYG text box 206 and the footer graphic image 210 can occupy the remaining area beneath the WYSIWYG text box 206 and the plain text box 208.

Referring to FIG. 3B, metadata of the first template 200 can include a general template characteristics data table 215 and a content object characteristics data table 230. The general template characteristics data table 215 can include general information about the template. As shown, information can include a “Media” data field 216, a “Template Shape” data field 217, a “Dimension Units” data field 218, a “Height” data field 219, a “Width” data field 220, a “Cartesian Origin” data field 221, a “Number of Objects” data field 222, a “Sequence of Objects” data field 223, an “Object Types” data field 224, and an “Object Shapes” data field 225. It is to be appreciated that more or less characteristics can be included in the general template characteristics data table 215. For instance, characteristics describing performance of the template in communication initiatives can be included.

The media data field 216 can include information relating to types of media the template has been used for. As shown in FIG. 3B, the template 200 has been used in print communications and online communications. The template shape data field 217 can include information relating to an overall shape of the template. The dimension units data field 218 can indicate whether the template is measured in Metric or English dimensions. The height data field 220 and the width data field 221 can give measurements of the template. Depending on a shape of the template, the general template characteristics data table 215 can include other measurement dimensions including, but not limited to, diameter, radius, base, thickness, length, etc. The Cartesian origin data field 221 can indicate an origin (0,0) for plotting content objects in the template. As shown, the Cartesian origin data field 221 indicates the lower left part of the template. As such, the lower left corner of the template would be the (0,0) coordinate. The number of objects data field 222 indicates the number of content objects in the template as being 5. The sequence of objects data field 223 describes a sequencing of the content objects in the template. The object types data field 224 lists each type of content object in the first template 200. The object shapes data field 225 lists a shape for each content object shape in the first template 200. The first template 200 only has rectangular shapes, so rectangle is the only listed shape in the object shapes data field 225.

The content object characteristics data table 230 can include general information about each of the content objects 202-210. The content object characteristics data table 230 can include a “Type” data field 231, a “Shape” data field 232, a “Rotational Angle” data field 233, a “Size” data field 234, a “Location Reference” data field 235, a “Location Coordinate Type” data field 236, a “Location Coordinates” data field 237, and an “Other” data field 238.

As shown in the content object characteristics data table 230, the content objects can be generally described. For instance, the second content object 204 data fields include general information about the second content object 204. The type data field 231 is filled in as “Image”, the shape data field 232 is filled in as “Rectangle”, the rotational angle data field 233 is filled in as “0”, the size data field 234 is filled in as “(1×6)”, the location reference data field 235 is filled in as “Upper Left”, the location coordinate type data field 236 is filled in as “Cartesian”, the location coordinates data field 237 is filled in as “(1,9)”, and the other data field 238 is filled in as “Header Image”.

Referring to FIG. 3C, an example of the general template characteristics data table 215 and the content object characteristics data table 230 in XML format is illustrated. The XML table 240 is for illustrative purposes only and is not meant to be limiting. FIG. 3C illustrates an example of how template metadata can be used to characterize a template. In this example, the template metadata describes the first template 200 illustrated in FIG. 3A. It is to be appreciated that the XML table 240 illustrates only one possible manifestation of template metadata. For instance, metadata can be provided in normalized relational tables, flat-file tables, or other suitable metadata tables. It is to be appreciated that many different characteristics and/or template design parameters can be envisioned and included as part of the template metadata depending on specific circumstances and intended applications for a given use.

Referring to FIG. 3D, the second template 250 is illustrated. The second template 250 can include a first content object 252, a second content object 254, a third content object 256, a fourth content object 258, and a fifth content object 260. As shown, the first content object 252 can be a background, the second content object 254 can be a plain text box, the third content object 256 can be an image, the fourth content object 258 can be a plain text box, and the fifth content object 260 can be a plain text box.

In one example, the second content object 254 can be a rectangular free text box, the third content object 256 can be a circular image, the fourth content object 258 can be a square free text box, and the fifth content object 260 can be a square fixed text box.

Referring to FIG. 3E, a general template characteristics data table 265 and a content object characteristics data table 280 are shown. The general template characteristics 285 can include general information about the second template 250. As shown, information can include a “Media” data field 266, a “Template Shape” data field 267, a “Dimension Units” data field 268, a “Height” data field 269, a “Width” data field 270, a “Cartesian Origin” data field 271, a “Number of Objects” data field 272, a “Sequence of Objects” data field 273, an “Object Types” data field 274, and an “Object Shapes” data field 275. It is to be appreciated that more or less characteristics can be included in the general template characteristics data table 265. For instance, characteristics describing performance of the template in communication initiatives can be included.

The content object characteristics data table 280 can include general information about each of the second template content objects 252-260. The content object characteristics data table 280 can include a “Type” data field 281, a “Shape” data field 282, a “Rotational Angle” data field 283, a “Size” data field 284, a “Location Reference” data field 285, a “Location Coordinate Type” data field 286, a “Location Coordinates” data field 287, and an “Other” data field 288. As shown in FIG. 3E, the content object characteristics data table 280 is filled in for each of the second template content objects 252-260.

Generally, template metadata can be adapted to include fields related to descriptive information about content objects in the template. In one embodiment, template metadata can include unstructured metadata attributes that characterize associations between a template and related communications initiatives and associated contextual information. For instance, free text can be added to template metadata. Generally, free text can include a variety of information found pertinent to analyzing the template and/or content objects that does not fit into the structured metadata fields.

In one embodiment, the template process 100 and/or the content object process 150 can include a step of rationalizing, abstracting, or summarizing data to determine how much data is attached to metadata of a template. For instance, statistical summarization and/or archiving can be implemented to reduce a size of the template.

It is to be appreciated that the above disclosed description provides one example of a particular manifestation of template metadata. Several schemas are possible, and the particular schema described herein is not meant to be exhaustive, nor is it intended to limit the scope of the present invention. Establishment and implementation of template metadata, regardless of various alternative schemas, is encompassed within the scope of the present invention.

### A First Embodiment of a Template Metadata System

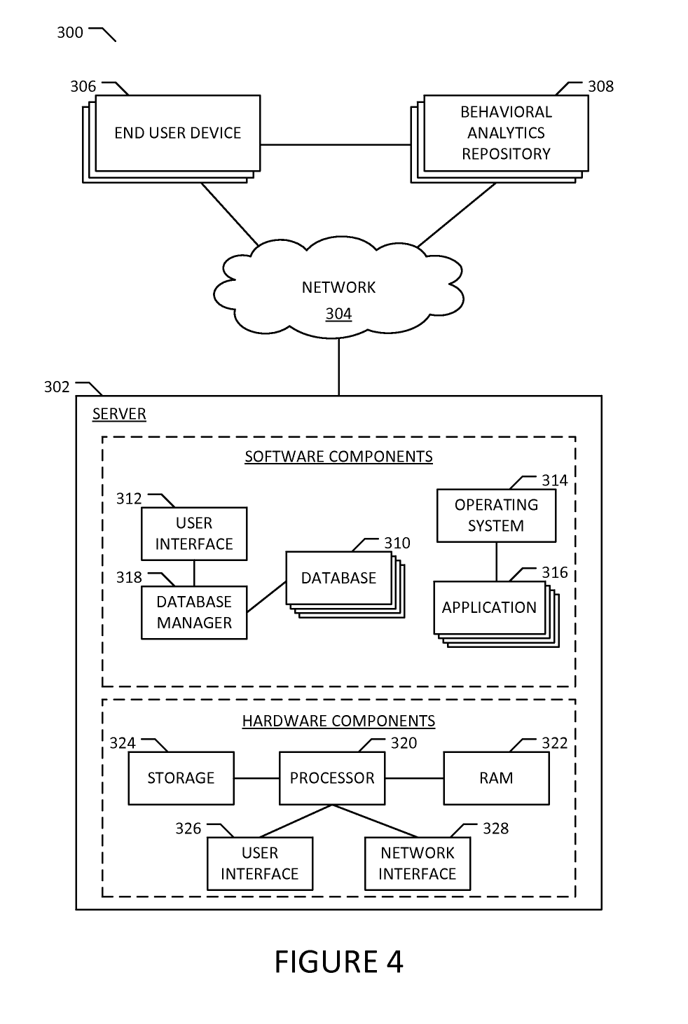

Referring to FIG. 4, a detailed diagram of an embodiment 300 showing a template metadata system is illustrated. The template metadata system 300 can be implemented to create a template database including templates having descriptive data associated with each template.

Generally, the template metadata system 300 can include a server 302, a network 304, one or more end user devices 306, and one or more behavioral analytics repositories 308.

Generally, a collection of templates can be stored in the server 302. In one embodiment, the collection of templates can be stored in the one or more databases 310. It is to be appreciated that the collection of templates can be stored externally to the server 302. For instance, the databases 310 can be remotely located from the server 302. Typically, a user can access the database 310 and search, query, filter, and/or prioritize the collection of templates. For instance, the database 310 can be accessed through a web interface. In another instance, the user can have direct access to the database 310. For example, the server 302 can include a user interface or web based interface 312 to access the database 310.

The server 302 can represent a server or another powerful, dedicated computer system that can support multiple user sessions. In some embodiments, the server 302 can be any type of computing device including, but not limited to, a personal computer, a game console, a smartphone, a tablet, a netbook computer, or other computing devices. In one embodiment, the server 302 can be a distributed system wherein server functions are distributed over several computers connected to a network. The server 302 can have a hardware platform and software components.

The software components of the server 302 can include the one or more databases 310 which can store a plurality of templates. The software components can also include an operating system 314 on which various applications 316 can execute. A database manager 318 can be an application that runs queries against the databases 310. In one embodiment, the database manager 318 can allow interaction with the databases 310 through an HTML user interface on an end user device 306.

In one embodiment, the server 302 can include a program or application to create a template. The template generation program can include a plurality of descriptive data fields in metadata of the created template.

The hardware platform of the server 302 can include, but is not limited to, a processor 320, random access memory 322, and nonvolatile storage 324. The processor 320 can be a single microprocessor, multi-core processor, or a group of processors. The random access memory 322 can store executable code as well as data that can be immediately accessible to the processor. The nonvolatile storage 324 can store executable code and data in a persistent state.

The hardware platform can include a user interface 326. The user interface 326 can include keyboards, monitors, pointing devices, and other user interface components. The hardware platform can also include a network interface 328. The network interface 328 can include, but is not limited to, hardwired and wireless interfaces through which the server 302 can communicate with other devices including, but not limited to, the end user devices 306 and the behavioral analytics data repositories 308.

The network 304 can be any type of network, such as a local area network, wide area network, or the Internet. In some cases, the network 304 can include wired or wireless connections and may transmit and receive information using various protocols.

The one or more end user devices 306 can be any type of computing device on which a browser can operate. Examples of such devices can include, but are not limited to, desktop computers, laptop computers, tablet computers, mobile telephones, game consoles, network appliances, or any other web-enabled devices. In an embodiment, the end user devices 306 can have various hardware platforms on which a browser can execute. The browser can be used to access the HTML user interface of the database manager 318.

The template metadata system 300 can include a query program. In one embodiment, the query program can be implemented as an application. Generally, the application can be embodied on a variety of computing devices. For instance, the query program can be embodied on a smart phone, laptop, desktop, and tablet. The query program can provide access to the template database 310.

In one example, a marketing campaign designer can implement the query program to access the template database 310 via the end user device 306 having a web browser. While formulating a new communications initiative, the marketing campaign designer can search, filter, prioritize, and select templates based on descriptive characteristics of each template. Typically, template metadata can include information as illustrated in FIGS. 3B and 3E to help characterize properties of the template. It is to be appreciated that such properties can be specified in terms of either structured or unstructured metadata attributes.

General template characteristics, as previously disclosed, may be desirable in order to permit rapid searching for similar templates in terms of a number of content objects and/or types of shapes of content objects. General level searches may be of use in identifying templates with some common characteristics in order to allow for repurposing of templates. For instance, a designer can find a suitable template that only needs adjustments to a location of content objects in the template.

Where a more detailed search needs to be conducted, or a more close matching of available candidate to the design requirements, each content object included in the desired design may be further elaborated. The content object characteristics data tables 230,280 provide one example of detailed object level descriptions in the present invention.

Typically, the collection of templates can be searched by one of the end user devices 306. For instance, a marketing campaign designer can search the template collection for a template meeting design criteria outlined by the designer. For example, the designer may be interested in finding available templates that contain five content objects, including one photographic image object, one free-text object, two WYSIWYG text objects, and one artwork or logo image object, arranged from top to bottom and left to right such that two objects, center-aligned, appear on three horizontal layers. The designer can query a search of the collection of templates by specifying one or more of the parameters described above. The designer can run an application on the end user device 306 to search the template database and provide results listing templates meeting the above parameters.

In one embodiment, the behavioral analytics repository 308 can be a database where behavioral analytics data related to a template is consolidated and stored. For instance, after a communications initiative ends and behavioral analytics data related to the communications initiative is generated, the behavioral analytics data can be sent to the behavioral analytics data repository 308. If the template has participated in various initiatives, behavioral analytic data related to the template can be attached to metadata of the template. As behavioral analytics data is generated for the template, the behavioral analytics data can be stored in one of the behavioral analytics repositories 308. The behavioral analytics data stored in the behavioral analytics repositories 308 can be sent to the server 302. An application running on the server 302 can be adapted to update metadata of the template with the received behavioral analytics data. In some embodiments, the application can update the template metadata as new behavioral analytics data is generated. In one embodiment, the template metadata can be updated after an initiative the template participated in ends.

In one embodiment, the campaign designer can search based on historical performance of the templates with regard to intended market segments, geographic regions, and/or product categories. Since the historical impact of an initiative can be associated with or attached to a template, the templates can be searched without prior knowledge of initiatives the templates participated in. The marketing campaign designer can search for templates that have demonstrated a disproportionately positive contribution in the achievement of empirical market outcomes. The marketing campaign designer can then filter the templates based on those templates that have contributed disproportionately to desired outcomes with specific regard to the target market segments, geographies, and/or product categories most relevant to the objectives of the user.

Statistical analysis of a template can be enabled as behavioral analytics data and contextual data about an initiative the template participated in is captured. Statistical analysis can include, but is not limited to, a determination of a capacity of the template to contribute, positively or negatively, to an achievement of desired outcomes within a variety of contexts.

Embodiments of the present invention can be implemented to determine if a template (i) demonstrates a systematic pattern of contributing to disproportionately successful communications initiatives, (ii) demonstrates a systematic pattern of underperformance, and (iii) exhibits statistical differences in influencing outcomes when combined with other templates or contexts. For instance, a user may observe that communications initiatives including the template exhibit better than average results. In another instance, a user may observe that the template is tied to a disproportionate increase in results among a certain consumer market segment with regard to a certain product category and for certain geographies.

In one embodiment, a user can search for and select one or more templates for use in a communications initiative based on cumulative performance contributions of the one or more templates. For example, before a user begins preparing a communications initiative, the user can search for various templates that are relevant with regard to product category, geography, and/or target segment. The user may gain inspiration by reviewing templates that have proven successful in related product categories, geographies, and target segments.

### An Embodiment of a Template Database Query Process

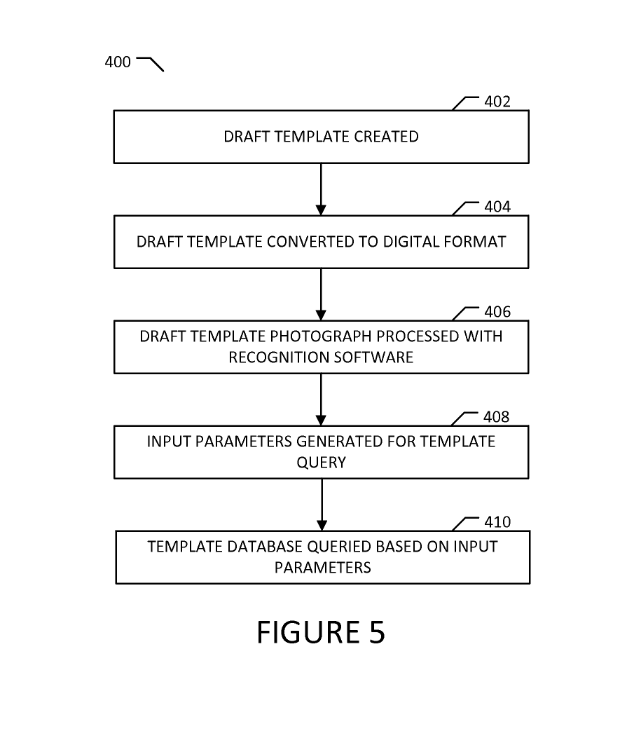

Referring to FIG. 5, a flow chart of a method or process 400 is illustrated. The process 400 can be implemented to query a collection of templates based on a draft template by implementing recognition software.

In block 402, a draft template can be created. For instance, a campaign designer may draw an outline of a template on a piece of paper. In another instance, a campaign designer may see a marketing campaign and be interested in using one of the designs as a template for their marketing campaign. Once the draft template has been created, the process 400 can move to block 404.

In block 404, the draft template can be converted to a digital format. It is to be appreciated that a variety of devices can be implemented to convert the draft template. For instance, a camera phone can be implemented to take a photograph of the draft template. In another instance, a camera can be implemented. In another embodiment, the draft template can be scanned to a digital file format. For instance, the draft template can be converted to a portable file document (PFD).

After the draft template has been converted, the resulting digital file can be processed with recognition software in block 406. For instance, image recognition software can be implemented. It is to be appreciated that other types of processing can be done to the draft template to determine general characteristics of the draft template. For instance, where a designer draws the template, optical character recognition (OCR) can be implemented to recognize text written by the designer. For example, if a designer created the first template 200 in FIG. 3A, OCR can be implemented to recognize text in the various boxes indicating that the designer would like to find templates having two image content objects and two text content objects. Photo recognition could then be implemented to determine the shapes of the content objects.

In block 408, input parameters can be generated based on the software recognition processing. In one embodiment, the input parameters can be generalized to match a data format of a database of templates having descriptive metadata. Generally, input parameters can include, but are not limited to, number of content objects, size of template, type of template, type of content objects, and intended media. It is to be appreciated that one or more recognition software types can be implemented to generate the input parameters.

Once the input parameters have been generated, a template database can be queried based on the input parameters in block 410. The input parameters can be implemented in a search engine of a template database having one or more templates with descriptive metadata.

In one embodiment, the recognition process 400 can implement photo recognition software. For example, a draft template can be converted to a digital file. Once the draft template digital file is created, an application or program can be implemented to compare the draft template digital file with a database of template files. For instance, the application can perform a comparative analysis of the draft template digital file with the database of templates files. Based on a predetermined set of parameters, the application can present a user with one or more templates having similar characteristics to the draft template. For instance, the recognition software may determine that the draft template has 3 content objects. The recognition software may further determine that 1 content object is an image, 1 content object is text, and 1 content object is an image. The application may then return each template in the database having 3 content objects, two of which are images and one a text box. The user can further refine the search by applying one or more parameters to the search.

### A Second Embodiment of a Template Metadata System

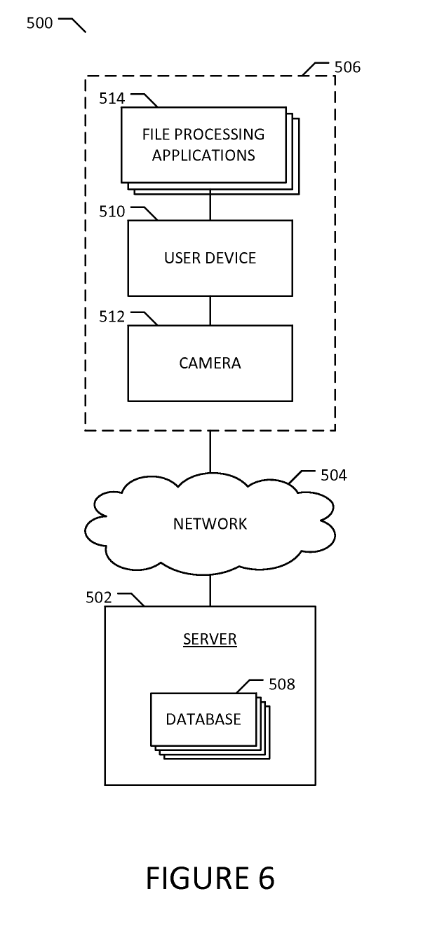

Referring to FIG. 6, a detailed diagram of an embodiment 500 showing a template metadata system implementing recognition software is illustrated. The recognition system 500 can include a database of templates having descriptive metadata for querying. Generally, the recognition system 500 can implement processing or recognition applications to generate search parameters for querying the template database.

In one embodiment, the recognition system 500 can include a server 502, a network 504, and a processing system 506.

The server 502 can represent a server or another powerful, dedicated computer system that can support multiple user sessions. In some embodiments, the server 502 can be any type of computing device including, but not limited to, a personal computer, a game console, a smartphone, a tablet, a netbook computer, or other computing devices. In one embodiment, the server 502 can be a distributed system wherein server functions are distributed over several computers connected to a network. The server 502 can have a hardware platform and software components. Generally, the server 502 can include one or more databases 508.

The network 504 can be any type of network, such as a local area network, wide area network, or the Internet. In some cases, the network 504 can include wired or wireless connections and may transmit and receive information using various protocols.

The processing system 506 can include a user device 510, a camera 512, and one or more file processing applications 514.

The user device 510 can be any type of computing device on which a browser can operate. Examples of such devices can include, but are not limited to, desktop computers, laptop computers, tablet computers, mobile telephones, game consoles, network appliances, or any other web-enabled devices. In an embodiment, the user device 510 can have various hardware platforms on which a browser can execute. The browser can be used to access an HTML user interface of the database 508.

The camera 512 can be a standalone digital camera, a smart phone camera, or any other type of camera that can produce digital images. For instance, the user device 510 can be a smart phone and the camera 512 can be an integrated part of the smart phone.

Typically, the file processing applications 514 can include, but are not limited to, photo recognition software, image recognition software, facial recognition software, and optical character recognition software. It is to be appreciated that other types of file processing software can be implemented in the present invention. In one embodiment, the file processing applications 514 can be stored and run on the user device 510. In another embodiment, the file processing applications 514 can be stored on the server 502, but run on the user device 510. In yet another embodiment, the file processing applications 514 can be stored and run on the server 502. For instance, a user may upload an image to the server 502 for processing by the file processing applications 514.

Generally, a collection of templates can be stored in the server 502. In one embodiment, the collection of templates can be stored in the one or more databases 508. It is to be appreciated that the collection of templates can be stored externally to the server 502. For instance, the databases 508 can be remotely located from the server 502.

Typically, a user can access the database 508 and search, query, filter, and/or prioritize the collection of templates. For instance, the database 508 can be accessed through a web interface. In another instance, the user can have direct access to the database 508. For example, the server 502 can include a user interface or web based interface to access the database 508.

In one example, a user may sketch a design with which to find available templates suitable for rendering a design similar to the sketch. In another example, the user may see a document or display and want to find available templates similar to the document or display. The user can then replicate the document or display in template form. In yet another example, a user may see a document or display that inspires in them a particular design layout and the person may seek suitable templates.

Generally, a user may take a photograph of a sketch, document, or display by a smart phone, camera, tablet, webcam, or other photo imaging device. After taking the photograph, the photograph can be processed by photo recognition technology in order to characterize attributes of the sketch, document, or display.

In one embodiment, the recognition system 500 can implement photo recognition as a means of capturing and/or specifying properties, characteristics, attributes, and template metadata of a document. The recognition system 500 can be implemented to find one or more templates, similar to the document, from a collection of templates by filtering, comparing, analyzing, and otherwise processing the document. In one embodiment, the recognition system 500 can generate results based on a degree to which characteristics, attributes, properties, and/or template metadata from the document correspond to characteristics of each template in the collection.

For example, photo recognition software can be implemented to generate input parameters for discovering pre-existing templates from among a collection of templates stored in the template database 508. Generally, templates in the database 508 can be processed, prioritized, filtered, evaluated, and/or compared with regard to a degree to which the template matches characteristics of the photographed sketch, document, or display. In some embodiments, the populated templates from an initial search can be further processed based on other metadata characteristics as needed.

In one embodiment, the processing system 506 can be implemented to populate metadata of a plurality of templates to be included in the databases 508. For instance, a template can be processed with one or more recognition software applications running on the user device 510. After processing the template, metadata parameters related to the template can be generated. The generated data from the recognition software can be populated into metadata for the template. Generally, after a template is processed by recognition software, the generated data can be stored in the databases 508 along with the template. Typically, a plurality of templates can be processed by the processing system 506 to populate the databases 508 with a collection of templates having enhanced metadata. Generally, the enhanced metadata stored in the databases 508 can include information about the templates and content objects included in the templates.

In one embodiment, a predetermined number of parameters can be generated for each template. For instance, parameters describing the template and content objects included in the template can be generated from the recognition software. The parameters can be stored in metadata of each of the templates and be available for search.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

1. (canceled)

2. (canceled)

3. (canceled)

4. (canceled)

5. (canceled)

6. (canceled)

7. A template metadata system comprising:
at least one processor;
at least one computer-readable storage media having stored thereon computer-executable instructions that, when executed by the at least one processor, causes the system to perform a method, the method comprising the following:
defining general characteristics of a template having one or more content object;
defining each content object included in the template;
generating data related to (i) the template and (ii) the one or more content objects; and
attaching the data to metadata of the template.

8. The template metadata system of claim 7, the method further comprising the steps of:
identifying a number of the one or more content objects;
categorizing each of the content objects; and
identifying a location of each content object in the template.

9. The template metadata system of claim 7, wherein defining the general characteristics of the template include determining (i) a shape of the template, (ii) a media type for the template, (iii) a height of the template, (iv) a width of the template, (v) a location origin, and (vi) a sequence of the content objects.

10. The template metadata system of claim 9, wherein defining the content object includes determining (i) a type of the content object, (ii) a shape of the content object, (iii) a rotational angle of the content object, (iv) a size of the content object, (v) a location reference of the content object, (vi) a location coordinate type of the content object, and (vii) location coordinates of the content object.

11. The template metadata system of claim 7, the system further comprising:
at least one database adapted to store a plurality of templates.

12. A method performed on a computer processor, said method comprising:
defining general characteristics of a template having one or more content objects;
defining each content object included in the template;
generating input parameters based on (i) the general characteristics of the template and (ii) the one or more content objects;
querying a template database based on the input parameters.

13. The method of claim 12, wherein the input parameters include fi) how many content objects are in the template, (ii) a categorization of each content object in the template, (iii) a shape of the template, and (iv) a shape of each of the content objects.

14. (canceled)

15. (canceled)

16. (canceled)

17. The method of claim 12, wherein the template database includes a plurality of templates, each of the templates having metadata.

18. The method of claim 17, wherein the template metadata includes one or more characteristics describing the template.

19. The method of claim 18, wherein the characteristics describing the template include (i) a shape of the template, (ii) a media type for the template, (iii) a height of the template, (iv) a width of the template, (v) a location origin, and (vi) a sequence of content objects included in the template.

20. The method of claim 17, wherein the template metadata includes one or more characteristics describing each content object included in the template.

21. The method of claim 20, wherein the characteristics describing the content objects include (i) a type of the content object, (ii) a shape of the content object, (iii) a rotational angle of the content object, (iv) a size of the content object, (v) a location reference of the content object, (vi) a location coordinate type of the content object, and (vii) location coordinates of the content object.

22. A template metadata system comprising:
at least one processor;
an imaging device; and
at least one computer-readable storage media having stored thereon computer-executable instructions that, when executed by the at least one processor, causes the system to perform a method, the method comprising the following:
using said imaging device to create a digital image of a draft template;
processing the digital image with recognition software, wherein the processing includes (i) defining general characteristics of the draft template, (ii) defining one or more content objects included in the draft template, and (iii) generating input parameters based on (a) the general characteristics of the draft template and (b) the one or more content objects; and
querying a template database based on the input parameters.

23. The template metadata system of claim 22, wherein the imaging device is selected from the group consisting of a smart phone, a digital camera, a tablet, a webcam, and a scanner.

24. The template metadata system of claim 22, wherein the recognition software includes optical character recognition software, photo recognition software, and image recognition software.

25. The template metadata system of claim 22, wherein the template database includes a plurality of templates, each of the templates having metadata.

26. The template metadata system of claim 25, wherein the template metadata includes one or more characteristics describing the template.

27. The method of claim 26, wherein the characteristics describing the template include (i) a shape of the template, (ii) a media type for the template, (iii) a height of the template, (iv) a width of the template, (v) a location origin, and (vi) a sequence of content objects included in the template.

28. The method of claim 25, wherein the template metadata includes one or more characteristics describing each content object included in the template.

29. The method of claim 28, wherein the characteristics describing the content objects include (i) a type of the content object, (ii) a shape of the content object, (iii) a rotational angle of the content object, (iv) a size of the content object, (v) a location reference of the content object, (vi) a location coordinate type of the content object, and (vii) location coordinates of the content object.
